(19) United States
(12) Patent Application Publication
(10) Pub. No.: US 2004/0230918 A1
(43) Pub. Date: Nov. 18, 2004

(54) Window display controlling method, window display controlling apparatus, and computer readable record medium containing a program

(75) Inventor: Akira Maruyama, Gunma (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/453,567

(22) Filed: Jun. 4, 2003

Related U.S. Application Data
(63) Continuation of application No. PCT/JP00/08707, filed on Dec. 8, 2000.

(51) Int. Cl. G09G 5/00

(52) U.S. Cl. 715/856

(57) ABSTRACT

An active window display controlling unit displays an active window containing a selection object which is able to be selected by means of a pointer on a display unit. A related area setting unit sets a related area corresponding to the selection object in the active window. A pointer position monitoring unit monitors a position of the pointer on the display unit. A selection object display status controlling unit changes a display status of the selection object corresponding to the related area when the pointer monitoring unit detects that the pointer enters into the related area. Selection of the selection object by means of the pointer becomes easy and accurate, and the operability is improved.

### TECHNICAL FIELD

The present invention relates to a display control on an active window displayed on a display unit of a computer. For example, the present invention relates to a window display controlling method, a window display controlling apparatus applied the above method, and a computer readable record medium containing a program, suitable for use in a selecting operation by means of a pointer in a window displayed on a display unit of a personal computer.

### BACKGROUND ART

In recent years, a demand for personal computers increases. Other than a keyboard, a mouse is used as an input means for a personal computer.

In various operations such as Internet, personal computer communication and the like with a personal computer, the user is required to do inputting operations quickly and accurately with a keyboard or a mouse.

Meanwhile, even the aged persons have more opportunities to use personal computers in these years. For this, there is a demand for the use environment of personal computers where even aged persons or beginners can do the inputting operation quickly and accurately.

However, in a personal computer equipped with, for example, a small-sized display, windows, selection items (buttons or the like), a pointer and the like are displayed small, which degrades the visibility and operability. This causes difficulty in operating the pointer displayed on the display with a mouse to select a selection item formed in a window.

Improvement of resolution of the display or the like may improve the visibility to some degree. However, even if the resolution of the display is improved, the difficulty in selecting a small selection item with a small pointer may not be improved so much for an aged person or a person having week sight.

If a new key or button is added to the keyboard or mouse in order to improve the input speed, the user needs to learn the operation of the newly added key or button, which may cause difficulty in handling it particularly for aged persons, beginners and the like. Accordingly, there is a demand for the use environment of personal computers where the operability is improved with the existing hardware environment used.

In the light of the above problem, an object of the present invention is to provide a window display controlling method, a window display controlling apparatus and a computer readable record medium containing a program, which facilitate the operation of selecting a selection item with a pointer in an active window using an existing hardware resource, whereby selection of an selection object with a pointer becomes easy and accurate, and the operability is improved.

### DISCLOSURE OF THE INVENTION

In order to achieve the above object, the present invention provides a window display controlling method for displaying an active window containing a selection object which is able to be selected by means of a pointer on a display unit comprising the steps of changing a display status of the selection object when the pointer enters into a related area formed correspondingly to the selection object in the active window.

A direction of movement of the pointer may be monitored, and a display status of the selection object positioning in the direction of movement may be changed, if the pointer is moved.

The display status of the selection object may be changed by enlarging and displaying the selection object. Alternatively, the display status of the selection object may be changed by enlarging and displaying the selection object so that the pointer lies on the selection object.

The display status of the selection object may be changed by moving and displaying the selection object. Alternatively, the display status of the selection object may be changed by moving and displaying the selection object so that the pointer lies on the selection object.

The present invention further provides a window display controlling method for displaying a window containing a selection object which is able to be selected by means of a pointer on a display unit comprising the steps of monitoring a direction of movement of the pointer, and changing a display status of the selection object positioning in the direction of movement when the pointer is moved.

A display status of the selection object may be changed by enlarging and displaying the selection object. Alternatively, the display status of the selection object may be changed by enlarging and displaying the selection object so that the pointer lies on the selection object.

The display status of the selection object may be changed by moving and displaying the selection object. Alternatively, the display status of the selection object may be changed by moving and displaying the selection object so that the pointer lies on the selection object.

The present invention still further provides a window display controlling apparatus comprising an active window display controlling unit for displaying an active window containing a selection object which is able to be selected by means of a pointer on a display unit, a related area setting unit for setting a related area corresponding to the selection object in the active window, a pointer position monitoring unit for monitoring a position of the pointer on the display unit, and a selection object display status controlling unit for changing a display status of the selection object corresponding to the related area when the pointer position monitoring unit detects that the pointer enters into the related area.

When the pointer position monitoring unit detects that the pointer is moved, the selection object display status controlling unit may change the display status of the selection object positioning in a direction of movement of the pointer.

The present invention still further provides a window display controlling apparatus comprising a window display controlling unit for displaying a window containing a selection object which is able to be selected by means of a pointer on a display unit, a pointer position monitoring unit for monitoring a position of the pointer on the display unit, and a selection object display status controlling unit for changing a display status of the selection object positioning in a direction of movement of the pointer when the pointer position monitoring unit detects that the pointer is moved.

The present invention still further provides a computer readable record medium containing a program making a computer function as an active window display controlling unit for displaying an active window containing a selection object which is able to be selected by means of a pointer on a display unit, a related area setting unit for setting a related area corresponding to the selection object in the active window, a pointer position monitoring unit for monitoring a position of the pointer on the display unit, and a selection object display status controlling unit for changing a display status of the selection object corresponding to the related area when the pointer position monitoring unit detects that the pointer enters into the related area. When the pointer position monitoring unit detects that the pointer is moved, the selection object display status controlling unit may change a display status of the selection object positioning in a direction of movement of the pointer.

The present invention still further provides a computer readable record medium containing a program making a computer function as an active window display controlling unit for displaying an active window containing a selection object which is able to be selected by means of a pointer on a display unit, a pointer position monitoring unit for monitoring a position of the pointer on the display unit, and a selection object display status controlling unit for changing a display status of the selection object positioning in a direction of movement of the pointer when the pointer position monitoring unit detects that the pointer is moved.

The window display controlling method, the window display controlling apparatus and a computer readable record medium containing a program of this invention provide the following effects and advantages.

(1) When a pointer enters into a related area formed correspondingly to a selection object in an active window, a display status of the selection object is changed, whereby selection of the selection object becomes easy and the operability is improved. Even if a selection object is displayed small in a computer system or the like equipped with a small display when the user selects the selection object, for example, the user can select the selection object easily and accurately.

(2) A direction of movement of the pointer is monitored. When the pointer is moved, the display status of a selection object positioning in a direction of the movement is changed, whereby selection of the selection object becomes easy and accurate, and the operability is improved.

(3) The visibility of a selection object is improved, thus the user can select the selection object more easily.

(4) It becomes unnecessary for the user to operate a mouse or the like to move the pointer in order to put the pointer on a selection object. Thus, the user can select the selection object quickly.

### BRIEF DESCRIPTION OF DRAWINGS

FIG. 1 is a functional block diagram of a window display controlling apparatus according to an embodiment of this invention;

FIG. 2 is a block diagram showing a whole structure of a computer system being as an example where the window display controlling apparatus is applied;

FIGS. 3(a) through 3(c) and 4(a) through 4(c) are diagrams for illustrating display screens of a display;

FIGS. 5(a), 5(b), 6(a) and 6(b) are diagrams for illustrating changes in display status of (a) selection item(s);

FIG. 7 is a flowchart for illustrating a window display controlling method in the window display controlling apparatus according to the embodiment of this invention;

FIGS. 8 through 13 are diagrams showing examples of display screens of the display;

FIGS. 14(a), 14(b), 15(a) and 15(b) are diagrams for illustrating changes in display status of (a) selection item(s) according to a modification of the window display controlling apparatus according to the embodiment of this invention;

FIG. 16 is a flowchart for illustrating a window display controlling method according to the modification of the window display controlling apparatus according to the embodiment of this invention; and

FIGS. 17 through 22 are diagrams showing examples of display screens of the display.

### BEST MODE FOR CARRYING OUT THE INVENTION

Hereinafter, description will be made of an embodiment of the present invention with reference to the drawings.

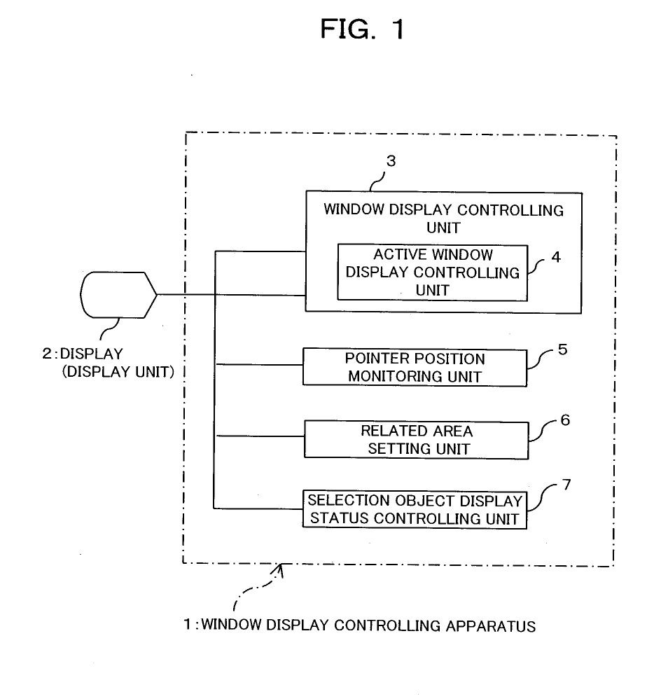

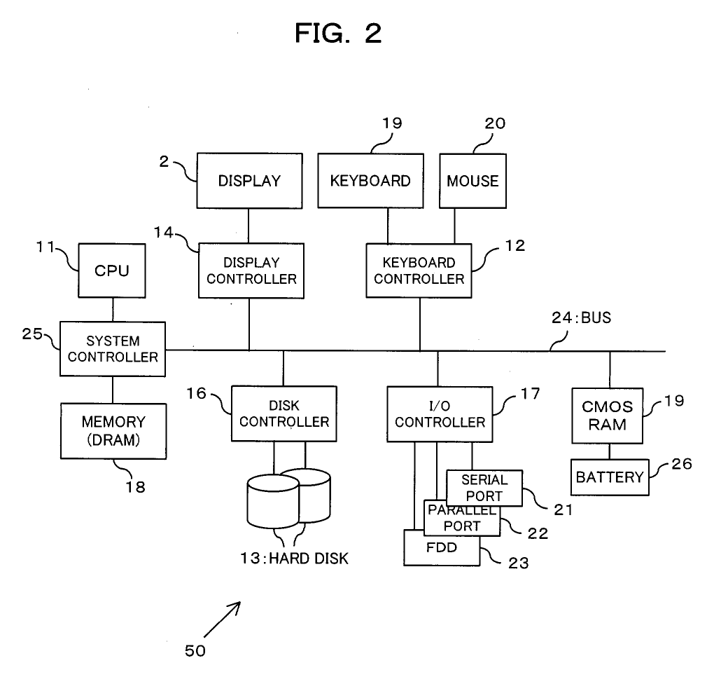

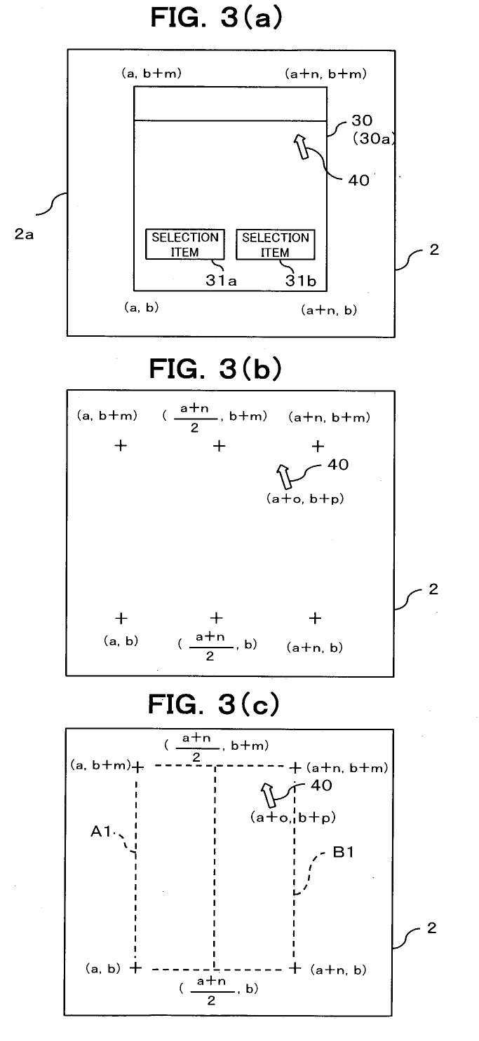

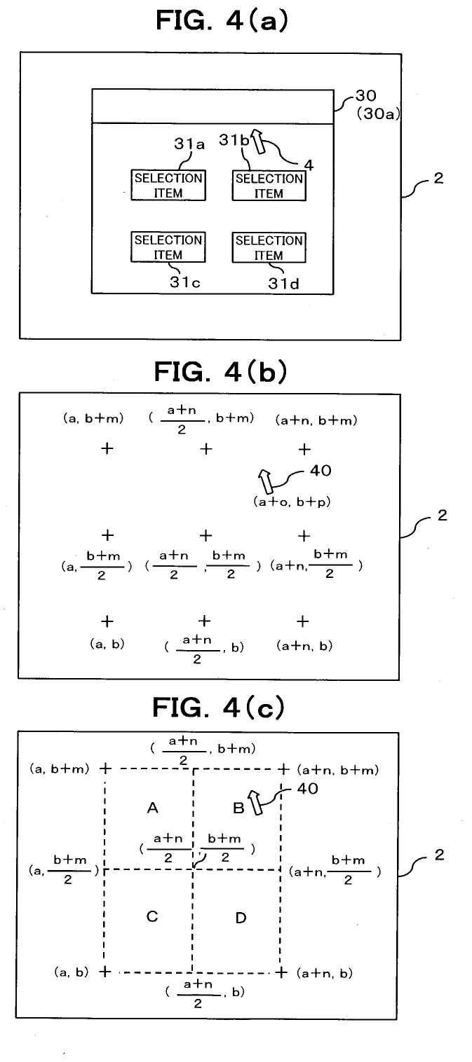

FIG. 1 is a functional block diagram of a window display controlling apparatus according to an embodiment of this invention. FIG. 2 is a block diagram showing a whole structure of a computer system being as an example of application of the window display controlling apparatus. FIGS. 3(a) through 3(c) and 4(a) through 4(c) are diagrams for illustrating display screens of a display.

Incidentally, FIG. 3(a) is a diagram showing an example of screen display where two selection items are shown. FIG. 3(b) is a diagram showing an example where coordinates in FIG. 3(a) are calculated. FIG. 3(c) is a diagram showing an example where the coordinates in FIG. 3(a) are divided. FIG. 4(a) is a diagram showing an example of screen display where four selection items are shown. FIG. 4(b) is a diagram showing an example where the coordinates in FIG. 4(a) are calculated. FIG. 4(c) is a diagram showing an example where the coordinates in FIG. 4(a) are divided.

A window display controlling apparatus 1 shown in FIG. 1 according to an embodiment of this invention controls window display on a display (display unit) 2 in a computer system 50 (refer to FIG. 2) equipped with, for example, a window system (Windows of Microsoft, X Window System on UNIX or the like). Hereinafter, description will be made of a case where the window display controlling apparatus 1 is applied to the computer system 50.

A window 30 is one of basic screen structural elements in GUI (Graphical User interface) environment, which is a frame in which data in work, a message or the like is displayed [refer to FIG. 3(a)] In the computer system 50, a plurality of windows 30 are displayed on the display 2 to perform different processes in the respective windows 30, whereby a plurality of processes can be performed in parallel.

Generally, there is arranged a selection item (selection object) 31a (31b) that the user can select with a pointer 40 in the window 30, as shown in FIG. 3(a). In FIG. 3(a), there are shown two selection items denoted by reference characters 31a and 31b. Hereinafter, when a selection item is denoted by a reference number, a reference number is followed by an English letter such as a, b, c, d or the like to be, for example, a reference number 31a if it is necessary to specify one of a plurality of selection items. When (an) arbitrary selection item(s) is designated, a reference number 31 is used.

The user operates a mouse 20 (refer to FIG. 2) to move the pointer 40, and clicks a button of the mouse 20 with the pointer 40 put on a selection item 31, thereby selecting the selection item 31.

In the window system, it is generally possible to display not less than two windows 30 on a display screen 2a of the display 2, and the user can do a work such as inputting, selection or the like in only an arbitrary one window 30 at a time. The window in which the work is feasible is called an active window 30a, displayed foremost on the display screen 2a of the display 2.

The window display controlling apparatus 1 comprises, as shown in FIG. 1, a window display controlling unit 3, a pointer position monitoring unit 5, a related area setting unit 6 and a selection object display status controlling unit 7. In concrete, a CPU 11 executes a program or the like stored in a hard disk 13 to realize a function of each of these units in the computer system 50, as will be described later.

The window display controlling unit 3 displays the window 30 containing a selection item (selection object) 31 that can be selected with the pointer 40 on the display 2. The window display controlling unit 3 also has a function as an active window display controlling unit 4 displaying an active window 30a containing a selection item 31.

The pointer position monitoring unit 5 monitors a position of the pointer 40 on the display 2. Namely, the pointer monitoring unit 5 constantly obtains a position of the pointer 40 on the display 2 as coordinate values, as shown in FIGS. 3(b) and 4(b), thereby monitoring a position of the pointer 40 on the display 2.

The related area setting unit 6 sets a related area corresponding to a selection item 31 in the active window 30a. In concrete, the related area setting unit 6 beforehand sets a related area formed correspondingly to each selection item 31 in the active window 30a.

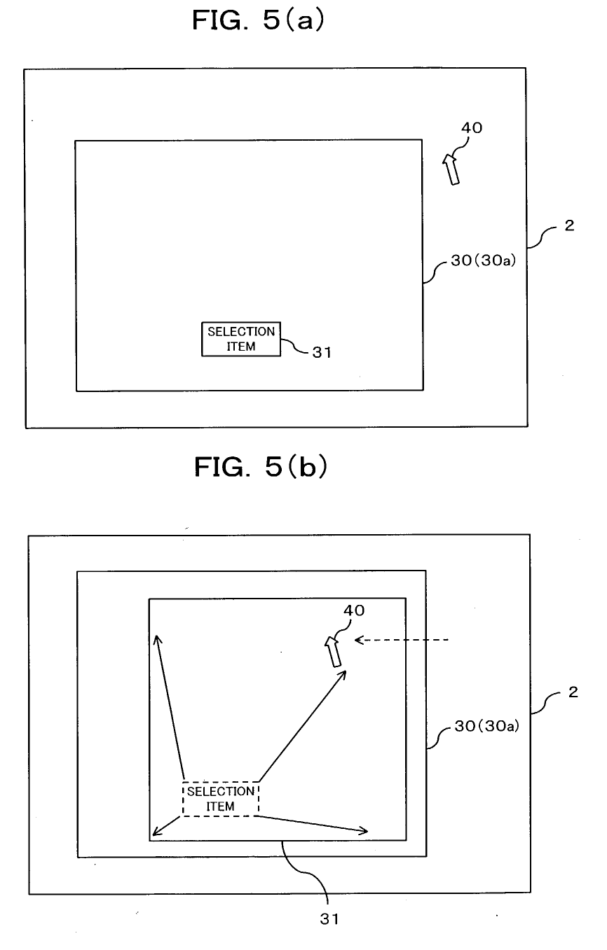

When the active window 30a contains one selection item 31 [refer to FIG. 5(a)], the related area setting unit 6 forms the same area as the active window 30a as a selection area corresponding to the selection item 31.

When the active window 30a contains two selection items 31a and 31b and these selection items 31a and 31b are arranged side by side in the horizontal direction as shown in FIG. 3(a), the related area setting unit 6 forms related areas A1 and B1 corresponding to the respective selection items 31a and 31b so that the active window 30a is divided into two areas at approximately mid position between the selection items 31a and 31b.

In the case shown in FIG. 3(a), for example, four corners of the active window 30a have coordinates (a,b), (a+n,b), (a,b+m) and (a+n,b+m), respectively, and an area enclosed by coordinates (a,b), ((a+n)/2,b), (a,b+m) and ((a+n)/2,b+m) is set as a related area A1 corresponding to the selection item 31a, as shown in FIG. 3(c). Similarly, an area enclosed by coordinates ((a+n)/2,b), (a+n,b), ((a+n)/2,b+m) and (a+n,b+m) is set as a related area B1 corresponding to the selection item 31b.

When the active window 30a contains four selection items 31a through 31d and these selection items 31a through 31d are arranged in a lattice in the horizontal and vertical directions as shown in FIG. 4(a), related areas A through D dividing the active window 30a into equal four areas approximately at the center position of the selection items 31a through 31d are formed as shown in FIG. 4(c), and the selection items 31a through 31d are related to the related areas A through D, respectively.

When one selection item 31 is arranged in the active window 30a, the related area setting unit 6 forms a related area having almost the same shape as the active window 30a correspondingly to the selection item 31. When not less than two selection items 31 are arranged in the active window 30a, the related area setting unit 6 divides the active window 30a into areas correspondingly to the respective selection items 31 to form related areas corresponding to the respective selection items 31.

In the case shown in FIG. 4(a), for example, four corners of the active window 30a are coordinates (a,b), (a+n,b), (a,b+m) and (a+n,b+m), and an area enclosed by coordinates (a,(b+m)/2), ((a+n)/2,(b+m)/2), (a,b+m) and ((a+n)/2,b+m) is set as a related area A corresponding to the selection item 31a, as shown in FIG. 4(c).

Similarly, an area enclosed by coordinates ((a+n)/2,(b+m)/2), (a+n,(b+m)/2), ((a+n)/2,b+m) and (a+n,b+m) is set as a related area B corresponding to the selection item 31b. An area enclosed by coordinates (a,b), ((a+n)/2,b), (a,(b+m)/2) and ((a+n)/2,(b+m)/2) is set as a related area C corresponding to the selection item 31c. An area enclosed by coordinates ((a+n)/2,b), (a+n,b), ((a+n)/2, (b+m)/2) and (a+n,(b+m)/2) is set as a related area D corresponding to the selection item 31d.

The selection object display status controlling unit 7 obtains coordinate information on each related area set correspondingly to each selection item 31 by the related area setting unit 6, and obtains position information (coordinate values) on the pointer 40 detected by the pointer position monitoring unit 5. The selection object display status controlling unit 7 can detect by means of the pointer position monitoring unit 5 that the pointer 40 enters into a related area.

When detecting by means of the pointer position monitoring unit 5 that the pointer 40 enters into a related area, the selection object display status controlling unit 7 changes a display status of a selection item (selection object) 31 corresponding to the related area.

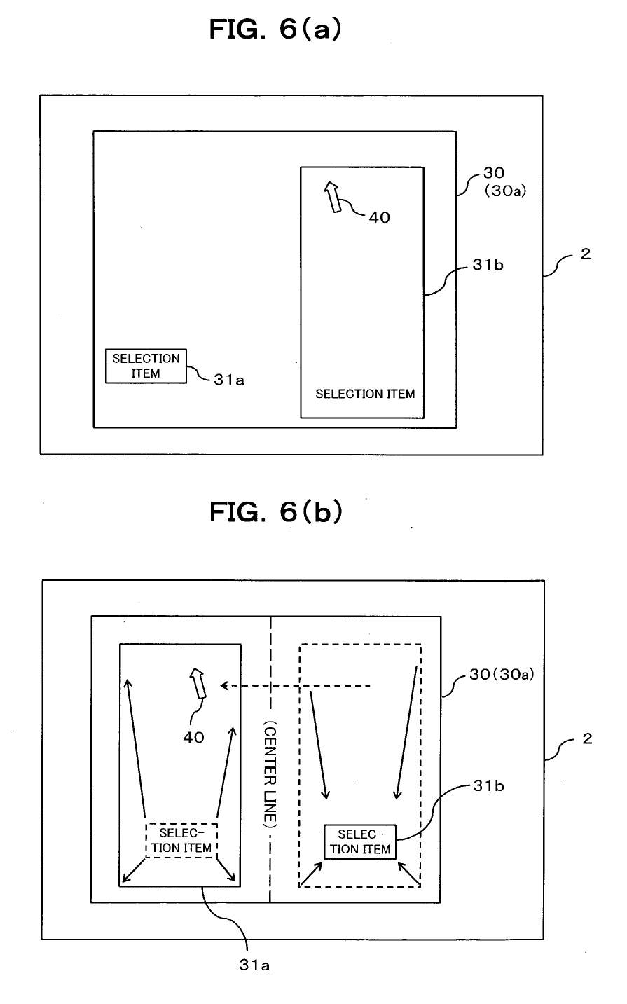

FIGS. 5(a), 5(b), 6(a) and 6(b) are diagrams for illustrating changes in display status of (a) selection item(s) 31. FIG. 5(a) is a diagram for illustrating a status before the selection item 31 is changed in the case where the active window 30a contains one selection item 31. FIG. 5(b) is a diagram for illustrating a status after the selection item 31 is changed. FIG. 6(a) is a diagram for illustrating a status at the time that the pointer 40 enters into one of related areas of selection items 31 in the case where the active window 30a contains two selection items 31. FIG. 6(b) is a diagram for illustrating a status of the selection item 31 after the pointer 40 moves into a related area of another selection item 31 from the status shown in FIG. 6(a).

In the case where the active window 30a contains one selection item 31 and the pointer 40 is positioned outside the active window 30a as shown in FIG. 5(a), when the user moves the pointer 40 into the inside of the active window 30a, the selection object display status controlling unit 7 changes the display status of the selection item 31.

More concretely, the selection object display status controlling unit 7 enlarges the selection item 31 so that the pointer 40 lies on the selection item 31, and displays them, as shown in FIG. 5(b). A size of the enlarged selection item 31 is beforehand set, and the enlarged size of the selection item 31 can be freely set.

In the case, as shown in FIG. 6(a), where the active window 30a contains two selection items 31a and 31b, and the display of the selection item 31b is enlarged so that the pointer 40 lies on the selection item 31b, when the user moves the pointer 40 into a related area [the left half area of the active window 30a in FIG. 6(b)] of the selection item 31a, the selection object display status controlling unit 7 changes the display status of the selection items 31a and 31b.

More concretely, the selection object display status controlling unit 7 enlarges the selection area 31a so that the pointer 40 lies on the selection area 31a, and displays them, while reducing the area of the selection item 31b to the original size before enlarged and displaying it, as shown in FIG. 6(b).

When detecting by means of the pointer position monitoring unit 5 that the pointer 40 is moved, the selection object display status controlling unit 7 changes the display status of a selection item (selection object) 31 [the selection item 31a in FIG. 6(b)] positioning in the direction in which the pointer 40 is moved.

Namely, when detecting by means of the pointer position monitoring unit 5 that the pointer is moved, the selection object display status controlling unit 7 obtains, using the pointer position monitoring unit 5, coordinates of the pointer 40 at least not less than twice, that is, coordinates of the pointer 40 before moved and coordinates of the pointer 40 after moved, and calculates a direction in which the pointer 40 is moved on the basis of the coordinates of the pointer 40 obtained not less than twice.

The selection object display status controlling unit 7 enlarges the selection item 31a positioned in the calculated direction in which the pointer 40 is moved, and displays it, as shown in FIG. 6(b). At this time, the selection item 31 may be enlarged and displayed so that the pointer 40 lies on the selection item 31. The selection object display status controlling unit 7 reduces the size of the selection item 31b that has been enlarged and displayed into the original size before the selection item 31b is enlarged and displayed.

The user can selectively set beforehand whether the selection item 31 is enlarged and displayed as above. A result of the selection is set as an ON or OFF flag. When the flag is ON, the selection object display status controlling unit 7 enlarges and displays the selection item 31. When the flag is set to OFF, the selection object display status controlling unit 7 does not enlarge the display of the selection item 31.

Next, description will be made of a concrete example of the computer system 50 being as an example of application of the window display controlling apparatus 1 according to the embodiment of this invention, with reference to FIG. 2.

The computer system (for example, a personal computer) 50 comprises, as shown in FIG. 2, a CPU 11, a keyboard controller 12, a hard disk 13, a display controller 14, a display (for example, CRT, LCD or the like; display unit) 2, a disk controller 16, an I/O controller 17, a memory (DRAM) 18, a CMOS RAM 191, a bus 24, a system controller 25 and a battery 26.

The hard disk 13 is a storage of the computer system 50, in which various application programs, data files, etc. are stored. A program for making the computer system 50 function as the window display controlling apparatus 1 according to this embodiment is stored in the hard disk 13, and the CMOS RAM 191 or the like, to be described later.

According to this embodiment, the hard disk 13 may be internal in or external to the computer system 50. The disk controller 16 controls operations of the hard disk 13.

In the CMOS RAM 191, there are stored information for setting the system environment, a program for making the computer system 50 perform an initial operation, etc. together with a program for making the computer system function as the window display controlling apparatus 1 according to this embodiment. The CMOS RAM 191 is backed up by the battery 26. If power supply from a power source not shown to the CMOS RAM 191 stops, the battery 26 supplies the power to the CMOS RAM 191.

The CPU 11 executes programs to perform various computing processes and control processes. The CPU 11 executes programs stored in the hard disk 13 and the CMOS RAM 191 to function as the window display controlling unit 3, the active window display controlling unit 4, the pointer position monitoring unit 5, the related area setting unit 6 and the selection object display status controlling unit 7 described above.

The memory 18 is used as a working area when the CPU 11 executes various computing processes. For example, the memory 18 contains coordinate values or the like of the pointer 40 obtained by the pointer position monitoring unit 5. The memory 18 temporarily contains information about coordinates and a size of the active window 30a, coordinates of a related area corresponding to each selection item 31 beforehand set by the related area setting unit 6, etc.

The keyboard 19 and the mouse 20 are input means used by the user to do various input works. Particularly, the mouse 20 is associated with a coordinate position of the pointer 40 on the display 2. The user operates the mouse 20 to move the pointer 40 on the display 2.

Additionally, the user operates the mouse 20 to put the pointer 40 on an arbitrary window 30 on the display 30, and selects the window 30 as the active window 30a by clicking a button of the mouse 20.

The keyboard controller 12 notifies the system controller 25 of input signals from the keyboard 19 or the mouse 20.

The display 2 is a display unit configured with, for example, a CRT, a liquid crystal monitor or the like. According to this embodiment, the display status of the display 2 is controlled by the display controller 14 operating according to an direction from the CPU 11 functioning as the window display controlling unit 3, the active window display controlling unit 4 and the selection object display status controlling unit 7.

The I/O controller 17 controls a serial port 21, a parallel port 22, a floppy disk drive (FDD) 23 and the like. The system controller 25 connects the CPU 11 to another controller or the like. The system controller 25 transmits various instructions from the CPU 11 to each controller, or signals from each controller to the CPU 11 or the memory 18.

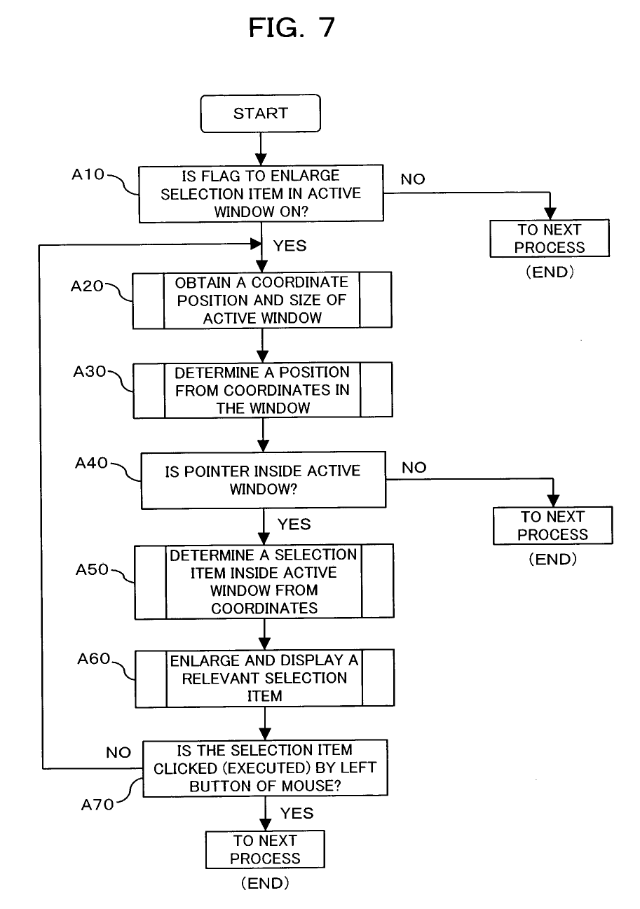

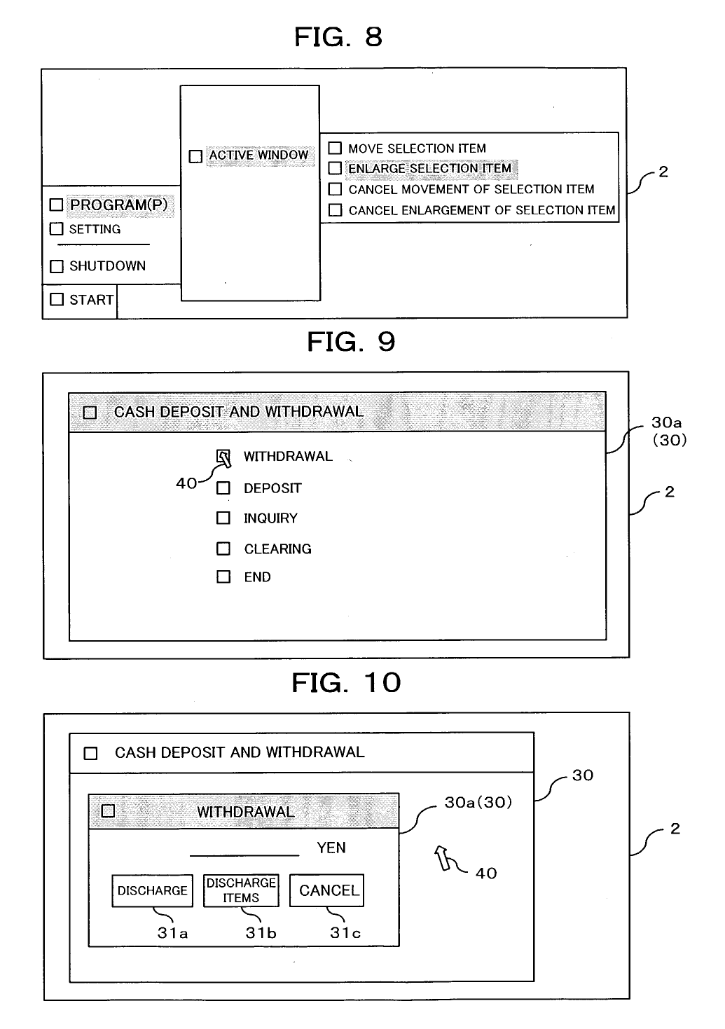

The window display controlling apparatus 1 according to this embodiment of this invention is configured as above. First, a window display controlling method in the window display controlling apparatus 1 will be described in accordance with a flowchart (steps A10 through A70) shown in FIG. 7 with reference to FIGS. 8 through 13. Incidentally, FIGS. 8 through 13 are diagrams showing examples of display screens of the display 2, which are examples of various display screens displayed when a cash deposit and withdrawal process is performed in the computer system 50 functioning as an ATM.

The user does setting to enlarge a display of a selection item 31 in a setting screen of windows of the computer system 50 as shown in FIG. 8, for example. Namely, the user starts an active window display control program stored in the hard disk 13 or the like of the computer system 50, and selects “enlarge selection item” to turn on a flag representing whether the display of the selection item 31 is to be enlarged or not.

Hereinafter, the description will be made by way of example where the user withdraws cash at a window of a bank, as shown in FIG. 9. When the user selects a withdrawal process in a selection screen shown in FIG. 9, the user inputs an amount of money, then selects, with the pointer 40, an arbitrary selection item 31 among selection items 31a through 31c of “discharge (selection item 31a),” “discharge items (selection item 31b”) and “cancel (selection item 31c),” as shown in FIG. 10.

The CPU 11 (selection object display status controlling unit 7) examines the flag representing whether the display of the selection item 31 is to be enlarged or not (step A10). When the flag is OFF (refer to NO route at step A10), the CPU 11 terminates the process and performs the next process.

When the flag representing whether the display of the selection item 31 is to be enlarged or not is ON (refer to YES route at step A10), the CPU 11 obtains a position (coordinates) and a size of the active window 30a from the active widow display controlling unit 4 (step A20). The CPU 11 (pointer position monitoring unit 5) determines a position (coordinates) of the pointer 40 on the display 2 (step A30).

The selection object display status controlling unit 7 determines whether the pointer 40 lies inside the active window 30a or not on the basis of the coordinates of the pointer 40 and information on the position of the active window 30a from the active window display controlling unit 4 (step A40).

When the pointer 40 is not inside the active window 30a as shown in FIG. 10 (refer to NO route at step A40), the CPU 11 terminates the process and performs the next process.

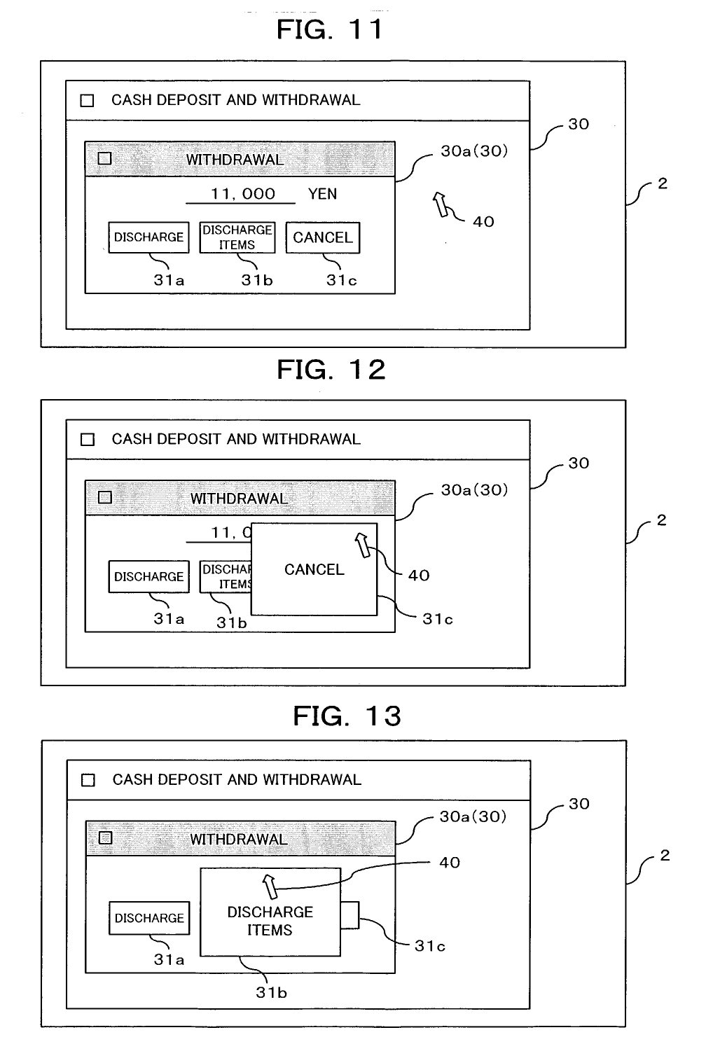

The user inputs items of an amount of money to be discharged using the keyboard 19 as shown in FIG. 11, then moves the pointer 40 to select “discharge items (selection item 31b).”

When the user operates the mouse 20 so that the pointer 40 enters into the active window 30a (refer to YES route at step A40), the CPU 11 (related area setting unit 6) sets a related area according to a selection item 31 (31a, 31b or 31c) arranged inside the active window 30a (step A50).

Namely, since three selection items 31a through 31c are arranged in the active window 30a shown in FIG. 10, the related area setting unit 6 divides the active window 30a into areas correspondingly to the respective selection items 31a through 31c to form three related areas. For example, when the three selection items 31a through 31c are arranged at equal intervals in the horizontal direction in the active window 30a as shown in FIGS. 10 and 11, the active window 30a is divided into three areas along the horizontal direction to form related areas corresponding to the selection items 31a through 31c.

The CPU 11 (selection object display status controlling unit 7) obtains information on a position of the pointer 40 and a direction in which the pointer 40 is moved from the pointer position monitoring unit 5, enlarges a relevant selection item 31, and displays it (step A60).

When the pointer 40 enters into a related area corresponding to the selection item 31c as shown in FIG. 12, for example, the selection object display status controlling unit 7 enlarges the selection item 31c so that the pointer 40 lies on the selection item 31c, and displays them, as shown in FIG. 12.

When the user further moves the pointer 40 toward the selection item 31b with the selection item 31c enlarged and displayed, and the pointer 40 lies on the selection item 31c as shown in FIG. 12, the selection object display status controlling unit 7 enlarges the selection item 31b so that the pointer 40 lies on the selection item 31b, displays them, while displaying the selection item 31c of a size before the selection item is enlarged.

Namely, the CPU 11 determines a selection item 31 to be enlarged and displayed on the basis of a position of the pointer 40 and a direction in which the pointer 40 is moved, and enlarges a relevant selection item 31 and displays it.

The CPU 11 determines whether the button of the mouse 20 is clicked or not with the pointer 40 put on the selection item 31 (step A70). When the left button of the mouse 20 is not clicked (refer to NO route at step A70), the procedure returns to step A20.

When the button of the mouse 20 is clicked with the pointer 40 put on the selection item 31 (refer to YES route at step A70), a process according to contents of the selection item 31 is performed.

In the active window display controlling apparatus 1 according to the embodiment of this invention, when the pointer 40 enters into a related area formed correspondingly to a selection item 31 in the active window 30a, the selection object display status controlling unit 7 changes the display status of the selection item 31, whereby selection of the selection item 31 becomes easy and the operability is improved.

Particularly, in a case where the user selects a selection item 31 in the computer system 50 or the like equipped with a small display 2, it is possible for the user to select the selection item 31 easily and accurately even if the selection item 31 to be selected is displayed small.

A direction in which the pointer 40 is moved is monitored. When the pointer 40 is moved, the selection object display status controlling unit 7 changes the display status of a selection item positioning in the direction of the movement, whereby the selection item 31 can be selected easily and accurately, and the operability can be improved.

By enlarging a display of the selection item so as to change the display status of the selection item 31, the visibility of the selection item 31 can be improved and the selection item 31 can be selected easily. Particularly, by enlarging and displaying the selection item 31 so that the pointer 40 lies on the selection item 31, it becomes unnecessary for the user to operate and move the mouse 20 or the like in order to put the pointer 40 onto the selection item 31. Accordingly, the user can select the selection item 31 quickly.

By moving a display of the selection item 31 so as to change the display status of the selection item 31, the visibility of the selection item 31 can be improved and the selection item 31 can be selected easily. Particularly, by moving and displaying the selection item 31 so that the pointer 40 lies on the selection item 31, it becomes unnecessary for the user to operate the mouse 20 or the like to move the pointer 40 in order to put the pointer 40 onto the selection item 31. Accordingly, the user can quickly select the selection item 31.

In the computer system 50, it is possible to improve the operability without providing a new button or the like to the keyboard 19 or the mouse 20, and with the existing hardware environment still used, which decreases the manufacturing cost and allows the user not to newly learn a manner of the use.

The present invention is effective in all fields using the computer system 50 such as banks, stock companies, insurance companies, schools, etc. Particularly, the present invention can improve the convenience for aged persons and beginners (in lower grades in primary schools or the like) whose number increases with recent expansion of the demand for personal computers. Further, the present invention is effective in emergency at the time of disaster or medical urgency.

Note that the prevent invention is not limited to the above examples, but may be modified in various ways without departing from the scope of the invention.

In the above embodiment, the selection object display status controlling unit 7 changes the display status of a selection item (selection object) 31 to enlarge and display the selection item 31 when the pointer enters into a related area formed correspondingly to the selection item 31, or the pointer is moved in the active window 30a, for example. However, the present invention is not limited to this example.

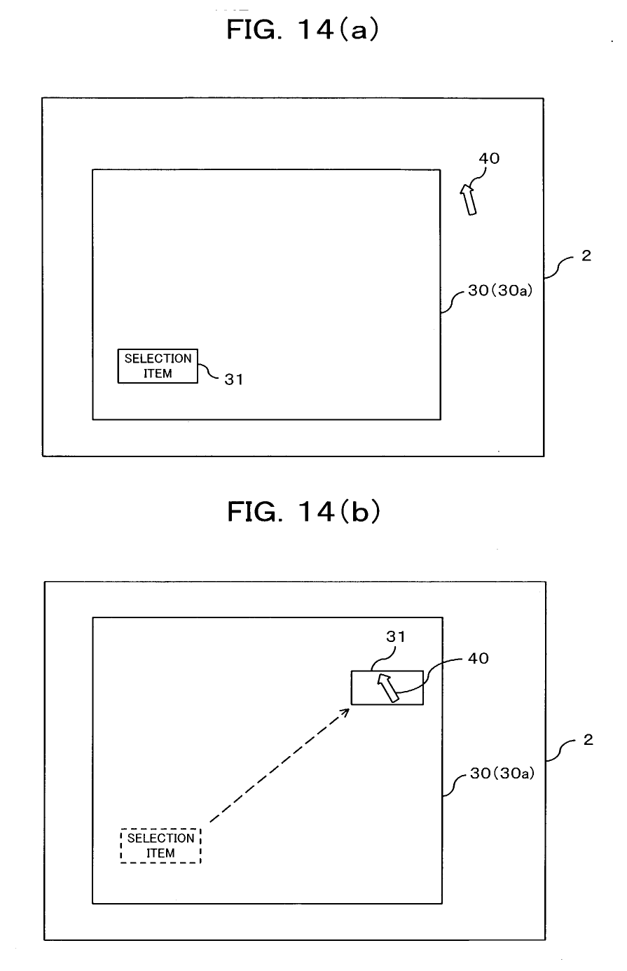

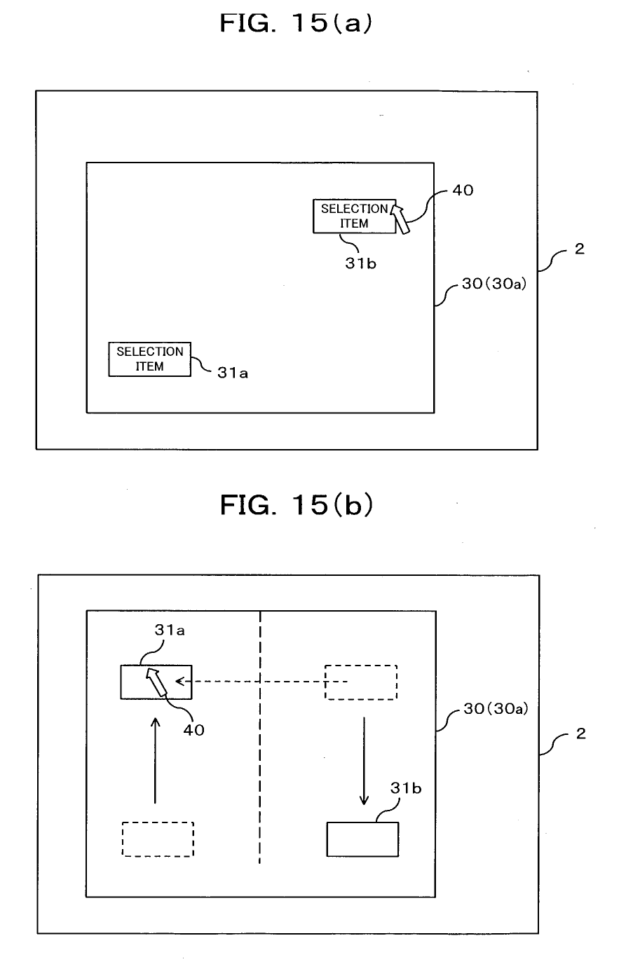

FIGS. 14(a), 14(b), 15(a) and 15(b) are diagrams for illustrating changes in display status of (a) selection item(s) according to a modification of the window display controlling apparatus according to the embodiment of this invention. FIG. 14(a) is a diagram for illustrating a state before the selection item 31 is changed in the case where the active window 30a contains one selection item 31. FIG. 14(b) is a diagram for illustrating a state after the selection item 31 is changed. FIG. 15(a) is a diagram for illustrating a state at the time that the pointer 40 enters into a related area of one of selection items 31 in the case where the active window 30a contains two selection items 31. FIG. 15(b) is a diagram for illustrating a state of the selection item 31 after changed at the time that the pointer 40 is moved into a related area of the other selection item 31 from the state shown in FIG. 15(a).

In the case where the active window 30a contains one selection item 31 as shown in FIG. 14(a), for example, the selection object display status controlling unit 7 may move the selection item 31 toward the pointer 40 when the pointer 40 enters into the active window 30a and display it, as shown in FIG. 14(b). Incidentally, a position of the moved selection item 31 is beforehand set. Particularly, it is desirable that the selection item 31 is moved so that the pointer 40 lies on the selection item 31.

In the case where the active window 30a contains two selection items 31a and 31b as shown in FIG. 15(a), assuming now that the selection item 31b has been moved so that the pointer 40 is lying on the selection item 31b. In this state, when the user moves the pointer 40 into a related area [the left half area of the active window 30a in FIG. 15(b)] of the selection item 31a, the selection object display status controlling unit 7 may move the selection item 31a toward the pointer 40, as shown in FIG. 15(b). In this case, it is desirable that the selection item 31 is so moved and displayed that the pointer 40 lies on the selection item 31, as well. At this time, the selection item 31b is put back in the original position before the selection item 31b is moved, and displayed.

When detecting by means of the pointer position monitoring unit 5 that the pointer 4 is moved, the selection object display status controlling unit 7 may change the display status of a selection item (selection object) 31 [selection item 31a in FIG. 15(b)] positioning in a direction of movement of the pointer 40.

Namely, when detecting by means of the pointer position monitoring unit 5 that the pointer 40 is moved, the selection object display status controlling unit 7 obtains coordinates of the pointer 40 using the pointer position monitoring unit 5 at least twice, before and after the pointer 40 is moved, and calculates a direction in which the pointer 40 is moved on the basis of the coordinates of the pointer 40 obtained not less then twice.

The selection object display status controlling unit 7 may move the selection item 31a positioning in the calculated direction of movement of the pointer 40 toward the pointer 40, and display it. At this time, it is desirable that the selection item 31 is moved so that the pointer 40 lies on the selection item 31, as well. The selection object display status controlling unit 7 moves the selection item 31b having been moved and displayed so as to put the selection item 31b back in the original position before the selection item 31b is moved.

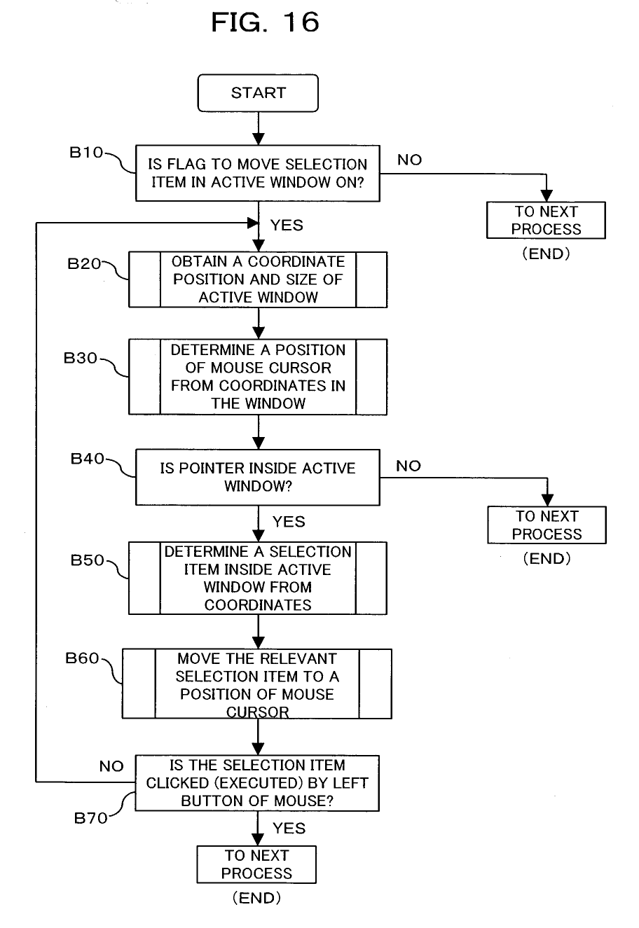

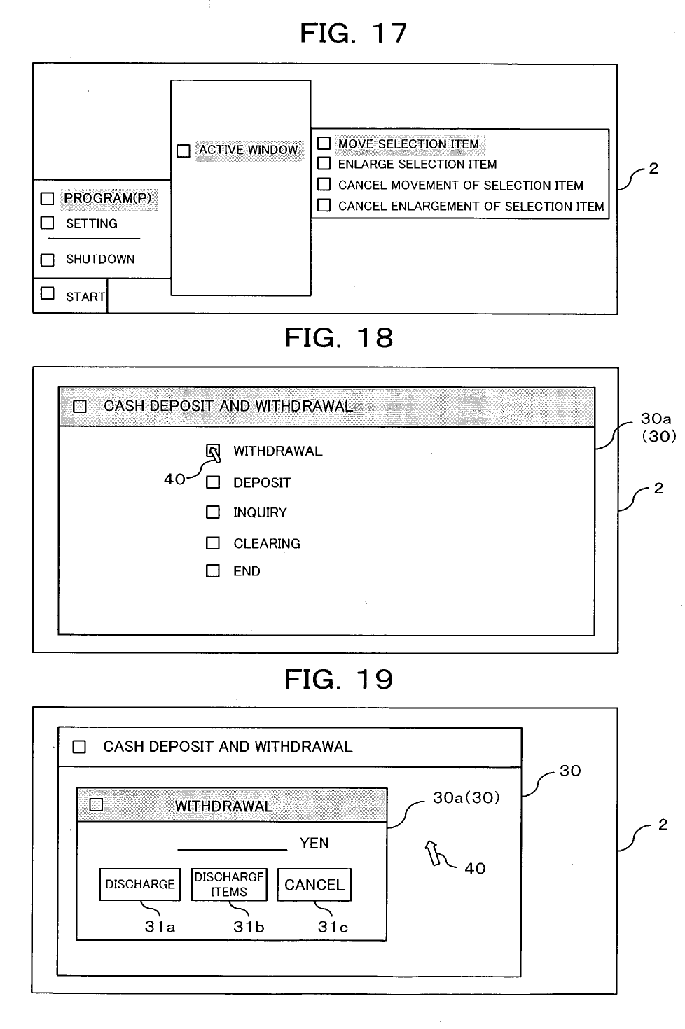

A window display controlling method used in a modification of the window display controlling apparatus 1 according to the embodiment of this invention will be now described in accordance with a flowchart (steps B10 through B70) shown in FIG. 16 with reference to FIGS. 17 through 22. FIGS. 17 through 22 are diagrams showing examples of display screens on the display 2, showing examples of various display screens displayed at the time of cash deposit and withdrawal process in the computer system 50 functioning as an ATM.

The user does setting to move a display of a selection item 31 in a setting screen of the windows of the computer system 50 shown in FIG. 17, for example. Namely, the user starts the active window display control program stored in the hard disk 13 or the like of the computer system 50, and selects “move selection item” to turn on a flag representing whether the display of the selection item 31 is to be moved or not.

Hereinafter, the description will be made by way of example where the user withdraws cash at a window of a bank, as shown in FIG. 18. When the user selects a withdrawal process in a selection screen shown in FIG. 18, the user inputs an amount of money, then selects, with the pointer 40, an arbitrary selection item 31 among selection items 31a through 31c of “discharge (selection item 31a),” “discharge items (selection item 31b)” and “cancel (selection item 31c),” as shown in FIG. 19.

The CPU 11 (selection object display status controlling unit 7) examines a flag representing whether the display of the selection item 31 is to be moved or not (step B10). When the flag is OFF (refer to NO route at step B10), the CPU 11 terminates the process, and performs the next process.

When the flag representing whether the display of the selection item 31 is to be moved or not is ON (refer to YES route at step B10), the CPU 11 obtains a position (coordinates) and size of the active window 30a from the active window display controlling unit 4 (step B20). The CPU (pointer position monitoring unit 5) determines a position (coordinates) of the pointer 40 on the display 2 (step B30).

The selection object display status controlling unit 7 determines on the basis of the coordinates of the pointer 40 and information on a position of the active window 30a from the active window display controlling unit 4 whether the pointer 40 lies in the active window 30a or not (step B40).

When the pointer 40 is not inside the active window 30a as shown in FIG. 19 (refer to NO route at Step B40), the CPU 11 terminates the process, and performs the next process.

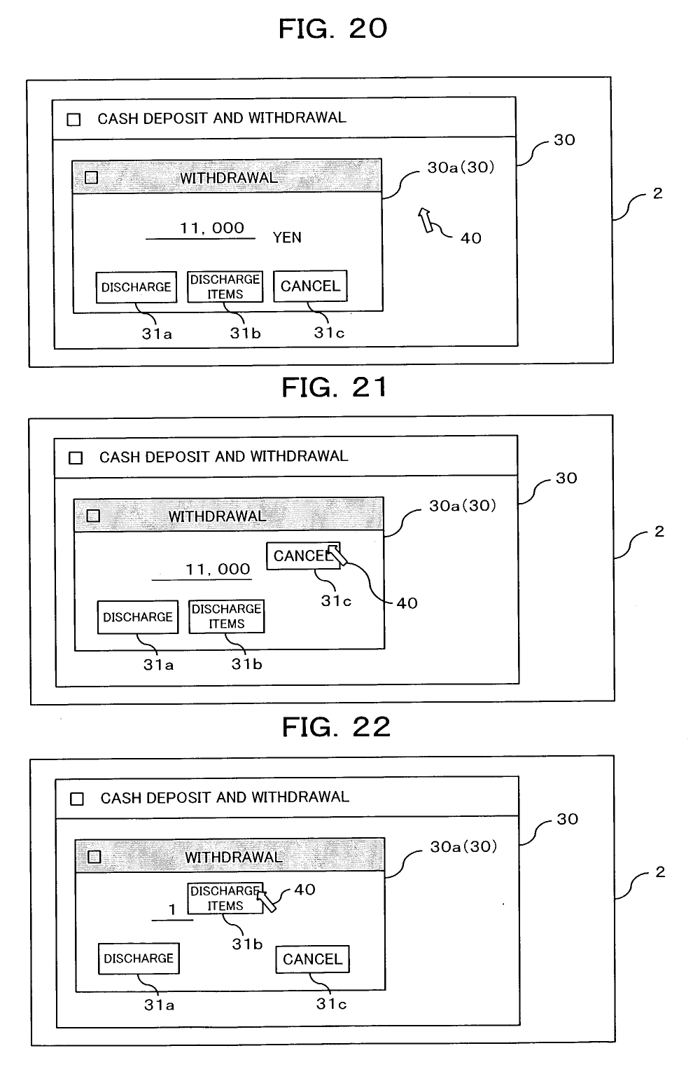

The user inputs items of an amount of money to be discharged using the keyboard 19 as shown in FIG. 20, then moves the pointer 40 to select “discharge items (selection item 31b).”

When the user operates the mouse 20 so that the pointer 40 enters into the active window 30a (refer to YES route at step B40), the CPU 11 (related area setting unit 6) sets related areas corresponding to selection items 31 (31a through 31c) arranged inside the active window 30a (step B50).

Namely, since three selection items 31a through 31c are arranged in the active window 30a shown in FIG. 19, the related area setting unit 6 divides the active window 30a into areas correspondingly to the selection items 31a through 31c to form three related areas. For example, when three selection items 31a through 31c are arranged at equal intervals in the horizontal direction in the active window 30a as shown in FIGS. 19 and 20, the active window 30a is divided into three areas along the horizontal direction, whereby related areas corresponding to the selection items 31a through 31c are formed.

The CPU 11 (selection object display status controlling unit 7) obtains information on a position of the pointer 40 and a direction in which the pointer 40 is moved from the pointer position monitoring unit 5, moves a relevant selection item 31 so that the pointer 40 lies on the selection item 31, and displays them (step B60).

When the pointer 40 enters into a related area corresponding to the selection item 31c as shown in FIG. 21, for example, the selection object display status controlling unit 7 moves the selection item 31 so that the pointer 40 lies on the selection item 31c, and displays them, as shown in FIG. 21.

When the user further moves the pointer 40 toward the selection item 31b with the selection item 31c moved and displayed, and with the pointer 40 put on the selection item 31c as shown in FIG. 21, the selection object display status controlling unit 7 moves the pointer 40 so that the pointer 40 lies on the selection item 31b, and displays them, while putting the selection item 31c back to the original position before the selection item 31c is moved and displaying it.

Namely, the CPU 11 determines a selection item 31 to be moved and displayed on the basis of a position of the pointer 40 and a direction in which the pointer 40 is moved, moves a relevant selection item 31 and displays it.

The CPU 11 determines whether the button of the mouse 20 is clicked or not with the pointer 40 put on the selection item 31 (step B70). When the left button of the mouse 20 is not clicked (refer to NO route at step B70), the procedure returns to step B20.

When the button of the mouse 20 is clicked with the pointer 40 put on the selection item 31 (refer to YES route at step B70), the CPU 11 performs a process according to contents of the selection item 31.

The window display controlling apparatus according to the modification of the invention can provide the same functions and effects as the window display controlling apparatus 1 described above.

In the above embodiment, when a selection item 31 is enlarged and displayed, the selection object display status controlling unit 7 enlarges and displays the selection item 31 so that the pointer 40 lies on the selection item 31. However, the present invention is not limited to this example. It is not always necessary that the pointer 40 lies on the selection item 31.

In the above embodiment, the changed selection item 31 is accommodated inside the active window 30a. However, the present invention is not limited to this example. The changed selection item 31 may be enlarged or moved, protruding from the active window 30a.

In the above embodiment, the mouse 20 is used to operate the pointer 40 on the display 2. However, the present invention is not limited to this example. Any one of various pointing devices such as a track pad, a track ball, a tablet, etc. may be used.

In the above embodiment, when the pointer 40 enters into a related area formed correspondingly to a selection item 31 or when the pointer 40 is moved, the selection object display status controlling unit 7 changes the display status of the relevant selection item 31. However, this invention is not limited to this example. It is alternatively possible to change the display status of the selection item 31 when either one of the above conditions is satisfied. Priorities may be set when these conditions are applied. In this case, the user or the like may freely set which one of the conditions has priority when the conditions are applied.

In the above embodiment, the window display controlling apparatus according to this invention is applied to a computer system. However, the present invention is not limited to this example. The present invention may be applied to menu selection or the like in cellular phones or various devices, for example. The present invention may be modified in various ways without departing from the scope of the invention.

The apparatus can be manufactured by persons having ordinary skilled in the art so long as the embodiment of this invention is disclosed.

### INDUSTRIAL APPLICABILITY

The window display controlling method, the window display controlling apparatus and a computer readable record medium containing a program according to this invention are useful in a display control on an active window to be displayed on a display unit of a computer. Particularly, the present invention is suited for a display control on an active window when a selection object is selected with a pointer in an active window displayed on a display unit of a personal computer.

1. A window display controlling method for displaying an active window containing a selection object which is able to be selected by means of a pointer on a display unit comprising the steps of:
changing a display status of said selection object when said pointer enters into a related area formed correspondingly to said selection object in said active window.

2. The window display controlling method according to claim 1, further comprising the steps of:
monitoring a direction of movement of said pointer; and
changing, if said pointer is moved, a display status of said selection object positioning in said direction of movement.

3. The window display controlling method according to claim 1, wherein said step of changing is performed by displaying the selection object enlarged.

4. The window display controlling method according to claim 1, wherein said step of changing is performed by displaying the selection object enlarged so that said pointer lies on said selection object.

5. The window display controlling method according to claim 1, wherein said step of changing is performed by displaying the selection object moved.

6. The window display controlling method according to claim 1, wherein said step of changing is performed by displaying the selection object moved so that said pointer lies on said selection object.

7. A window display controlling method for displaying a window containing a selection object which is able to be selected by means of a pointer on a display unit comprising the steps of:
monitoring a direction of movement of said pointer; and
changing a display status of said selection object positioning in said direction of movement when said pointer is moved.

8. The window display controlling method according to claim 7, wherein said step of changing is performed by displaying the selection object enlarged.

9. The window display controlling method according to claim 7, wherein said step of changing is performed by displaying the selection object enlarged so that said pointer lies on said selection object.

10. The window display controlling method according to claim 7, wherein said step of changing is performed by displaying the selection object moved.

11. The window display controlling method according to claim 7, wherein said step of changing is performed by displaying the selection object moved so that said pointer lies on said selection object.

12. A window display controlling apparatus comprising:
an active window display controlling unit for displaying an active window containing a selection object which is able to be selected by means of a pointer on a display unit;
a related area setting unit for setting a related area corresponding to said selection object in said active window;
a pointer position monitoring unit for monitoring a position of said pointer on said display unit; and
a selection object display status controlling unit for changing a display status of said selection object corresponding to said related area when said pointer position monitoring unit detects that said pointer enters into said related area.

13. The window display controlling apparatus according to claim 12, wherein, when said pointer position monitoring unit detects that said pointer is moved, said selection object display status controlling unit changes the display status of said selection object positioning in a direction of movement of said pointer.

14. A window display controlling apparatus comprising:
a window display controlling unit for displaying a window containing a selection object which is able to be selected by means of a pointer on a display unit;
a pointer position monitoring unit for monitoring a position of said pointer on said display unit; and
a selection object display status controlling unit for changing a display status of said selection object positioning in a direction of movement of said pointer when said pointer position monitoring unit detects that said pointer is moved.

15. A computer readable record medium containing a program making a computer function as;
an active window display controlling unit for displaying an active window containing a selection object which is able to be selected by means of a pointer on a display unit;
a related area setting unit for setting a related area corresponding to said selection object in said active window;
a pointer position monitoring unit for monitoring a position of said pointer on said display unit; and
a selection object display status controlling unit for changing a display status of said selection object corresponding to said related area when said pointer position monitoring unit detects that said pointer enters into said related area.

16. The computer readable record medium containing a program according to claim 15, wherein, when said pointer position monitoring unit detects that said pointer is moved, said selection object display status controlling unit changes a display status of said selection object positioning in a direction of movement of said pointer.

17. A computer readable record medium containing a program making a computer function as:
an active window display controlling unit for displaying an active window containing a selection object which is able to be selected by means of a pointer on a display unit;
a pointer position monitoring unit for monitoring a position of said pointer on said display unit; and
a selection object display status controlling unit for changing a display status of said selection object positioning in a direction of movement of said pointer when said pointer position monitoring unit detects that said pointer is moved.
